(19) United States
(12) Patent Application Publication
(10) Pub. No.: US 2018/0297695 A1
(43) Pub. Date: Oct. 18, 2018

(54) ROTARY WING AIRCRAFT

(71) Applicant: 4Front Robotics Ltd., Calgary (CA)

(72) Inventor: Alejandro Ramirez-Serrano, Calgary (CA)

(21) Appl. No.: 15/767,786

(22) PCT Filed: Oct. 14, 2016
(86) PCT No.: PCT/CA2016/051197

§ 371 Date: Apr. 12, 2018

Related U.S. Application Data
(60) Provisional application No. 62/242,351, filed on Oct. 16, 2015.

(51) Int. Cl. B64C 27/08; B64C 27/52; B64C 27/20; B64C 27/82

(52) U.S. Cl. CPC B64C 27/08; B64C 27/52; B64C 27/20; B64C 2201/108; B64C 2027/8281; B64C 2201/024; B64C 27/82

(57) ABSTRACT

A rotary wing aircraft having dual main rotor assemblies, wherein each main rotor is positioned laterally on linkages and are equidistant in a transverse direction from either side of the fuselage. The rotational axis of each rotor is moveable to alter an angle of the rotational axis to control both horizontal and vertical movement of the aircraft. The angle may be altered by rotating the rotational axes in a vertical plane that is parallel and spaced apart from the vertical plane of the longitudinal axis of the fuselage, or the rotational axes may be angled out of a vertical plane that is parallel and spaced apart from the vertical plane of the longitudinal axis of the fuselage. Each rotational axis may rotate independently.

### CROSS-REFERENCE TO RELATED APPLICATION

This application claims the benefit of U.S. Provisional Patent Application No. 62/242,351 filed on Oct. 16, 2015; the entire contents of U.S. Provisional Patent Application No. 62/242,351 are hereby incorporated by reference in its entirety.

### FIELD OF THE DISCLOSURE

The disclosure described herein relates to various embodiments for aircraft, and more in particular to various embodiments for a rotary wing aircraft.

### BACKGROUND

The following paragraphs are provided by way of background to the present disclosure. They are not, however, an admission that anything discussed therein is prior art or part of the knowledge of persons of skill in the art.

In comparison to airplanes, conventional helicopters provide significantly improved maneuverability. To achieve vertical motion, or maintain a hovering position, the main rotor blades of the helicopter rotate around a general vertical axis thereby creating lift.

One limitation of conventional helicopter rotor assemblies is that take-off and landing on non-horizontal surfaces is problematic. On such surfaces the axis around which the rotor is rotating is no longer positioned vertically, and the ability of the rotor to create lift without horizontal motion is compromised. Consequently, helicopter pilots are generally trained to avoid landing on surfaces at an angle in excess of 5 or 6 degrees (Helicopter Flight Training Manual, 2^{nd} edition, 2006, Transport Canada), and helicopter operations in, for example, mountainous terrain are challenging.

Another limitation of conventional helicopter rotor assemblies is that downward airflow, which ordinarily escapes to the sides and below the helicopter, also termed “airwash” or “downwash”, when obstructed re-enters the rotor space, thereby interfering with the lift forces generated by the rotor. Depending on the nature and proximity of the obstruction, this renders the helicopter difficult to control, and restricts the ability of helicopters to operate in confined areas, e.g. in canyons or between tall city buildings.

Thus there is a need in the art for improved helicopters capable of taking off and landing on uneven terrain and operating in confined areas.

### SUMMARY OF THE DISCLOSURE

The present disclosure relates to several implementations of rotary wing aircraft having unique helicopter rotor assemblies.

In one aspect, at least one example embodiment is provided in the present disclosure of a rotary wing aircraft comprising: a fuselage having a front end, a rear end and a longitudinal axis; and first and second main rotors, the first main rotor being coupled to the fuselage by a first linkage and supported for rotation around a first rotational axis, the second main rotor being coupled to the fuselage by a second linkage and supported for rotation around a second rotational axis so that the first and second main rotors may rotate around the two rotational axes, respectively, the two rotational axes being positioned equidistantly on either side of the longitudinal axis of the fuselage, the first and the second main rotors operable to control both horizontal and vertical movement of the aircraft, and the first and second linkages being moveable during use to alter the angle of the first rotational axis and the angle of the second rotational axis.

In another aspect, at least one example embodiment is provided in which, the rotary wing aircraft of the present disclosure further comprises: a tail propeller coupled to the fuselage by a third linkage and supported for rotation around a third rotational axis that is substantially vertical with respect to the vertical plane of the longitudinal axis of the fuselage.

In another aspect, at least one example embodiment is provided herein in which in the rotary wing aircraft of the present disclosure, the first and second main rotor rotate counter to each other.

In another aspect, at least one example embodiment is provided herein in which the first and second linkages are moveable so that the first rotational axis and the second rotational axis rotate in a vertical plane that is parallel and spaced apart from the vertical plane of the longitudinal axis of the fuselage.

In another aspect, at least one example embodiment is provided herein in which the first and second linkages are independently moveable with respect to one another so that the first and second rotational axes are at different angles in a vertical plane that is parallel and spaced apart from the vertical plane of the longitudinal axis of the fuselage.

In another aspect, at least one example embodiment is provided herein in which the first and second linkages comprise first and second spars, each spar transversally extending in opposite direction from the fuselage, and first and second rotor support structures at each distal end of the spar within which are first and second shafts, from which rotor blades radially extend, the first and second shafts being free to turn around first and second rotational axes, respectively, wherein each spar can be controlled to rotate around its transversally extending rotational axis permitting rotation of each shaft at different angles in a vertical plane that is parallel and spaced apart from the vertical plane of the longitudinal axis of the fuselage.

In another aspect, at least one example embodiment is provided herein in which the first and second linkages are constructed so that first and second rotational axes are angled out of a vertical plane that is parallel and spaced apart from the vertical plane of the longitudinal axis of the fuselage.

In another aspect, at least one example embodiment is provided herein in which the first and second linkages are moveable so that the first and second rotational axes pivot out of a vertical plane that is parallel and spaced apart from the vertical plane of the longitudinal axis of the fuselage.

In another aspect, at least one example embodiment is provided herein in which the first and second linkages are independently moveable with respect to one another so that the first and second rotational axes are pivoted at different angles out of a vertical plane that is parallel and spaced apart from the vertical plane of the longitudinal axis of the fuselage.

In another aspect, at least one example embodiment is provided herein in which the first and second linkages comprise first and second spars, each spar transversally extending in opposite directions from the fuselage, and distal portions of the spars are attached to first and second rotors, respectively, the first and second rotors having first and second rotational axes wherein each spar is further connected to a longitudinally extending rotatable connecting rod having an axis parallel relative to the longitudinal axis of the fuselage, and wherein rotation of the connecting rod can be controlled to permit pivoting of the first and second rotors at different angles out of a vertical plane that is parallel and spaced apart from the vertical plane of the longitudinal axis of the fuselage.

In another aspect, at least one example embodiment is provided herein in which the rotary wing aircraft comprises first and second ring structures that are co-located with and surround the first and second rotors respectively so that the first and second rotators rotate within the first and second fixed ring structures in use. In one example embodiment, the first and second ring structures are co-planar with the rotor blades. In another example embodiment, the first and second ring structures are non-co-planar with the rotor blades.

Other features and advantages of the present disclosure will become apparent from the following detailed description. It should be understood, however, that the detailed description, while indicating preferred implementations of the disclosure, are given by way of illustration only, since various changes and modifications within the spirit and scope of the disclosure will become apparent to those of skill in the art from the detailed description.

### BRIEF DESCRIPTION OF THE DRAWINGS

For a better understanding of the various example implementations described herein, and to show more clearly how these various embodiments may be carried into effect, reference will be made, by way of example, to the accompanying drawings which show at least one example embodiment and the drawings will now be briefly described. It is further noted that identical numbering of elements in different figures is intended to refer to the same element, possibly shown situated differently, at a different size, or from a different angle.

FIG. 1 shows an overhead plan view of a rotary wing aircraft in accordance with one example embodiment of the present disclosure.

FIG. 2 shows an overhead plan view of a rotary wing aircraft in accordance with another example embodiment of the present disclosure.

FIG. 3 shows a cut-away perspective view of a main rotor and linkage to a fuselage in accordance with one embodiment of such linkage.

FIG. 4 shows a three dimensional perspective view of a tail propeller and linkage to a tail boom in accordance with one embodiment of such linkage.

FIG. 5 shows an embodiment of a rotary wing aircraft comprising an embodiment of a fuel powered power plant assembly.

FIG. 6 shows an embodiment of a rotary wing craft with an electrically powered power plant assembly.

FIGS. 7A-C show an embodiment of a pitch assembly system to adjust the angle of attack of the blades of the main rotor.

FIG. 8 shows a perspective view an example embodiment of a tail propeller assembly.

FIGS. 9A-B show front views of a rotary wing aircraft in accordance with an example embodiment of the present disclosure in which the non-co-axial position of the first and second rotational axis is shown.

FIGS. 10A-B show movement of the main rotors along an axis Y in accordance with one embodiment of the present disclosure.

FIG. 11 shows an overhead view of a control system to achieve movement of the main rotors along an axis Y in accordance with one embodiment of the present disclosure.

FIGS. 12A-C show views of a rotary wing aircraft in which the rotors have linkages that are co-planar with respect to one another but rotational axes that are not co-planar with respect to one another, and in which the rotors have linkages that are co-planar with respect to one another and rotational axes that are co-planar with respect to one another.

FIG. 13 shows an isometric (three dimensional) perspective view of a rotary wing aircraft of the present disclosure.

FIGS. 14A-C show a side view of a tail propeller and different angles of attack.

FIGS. 15A-B show front views of a rotary wing aircraft in accordance with an example embodiment in which the rotors provide differential thrust.

FIGS. 16A-B show a side view (FIG. 16A) and perspective view (FIG. 16B) of a rotary wing aircraft in accordance with an example embodiment in which the rotors are rotated differentially about a transversal axis.

FIG. 17 shows an overhead view of a rotary wing aircraft in accordance with an example embodiment in which the rotors are differentially rotated about a transversal axis.

FIGS. 18A-B show a linkage permitting rotation of the rotors around an axis Y. Shown are an overhead view (FIG. 18B) and a cut-away perspective view of a main rotor and linkage to a fuselage (FIG. 18A).

FIGS. 19A-C show a linkage permitting pivoting of the rotors about a rotatable connecting rod. Shown are front views showing the rotors in a first pivoted position (FIG. 19A) and a second pivoted position (FIG. 19B), and an overhead view (FIG. 19C).

FIGS. 20A-B show a perspective view of a rotary wing aircraft and illustrates certain directions in which the rotors of the rotary wing aircraft of the present disclosure may be pivoted (FIG. 20A) and rotated (FIG. 20B) in accordance with various embodiments hereof.

The drawings together with the following detailed description make apparent to those skilled in the art how the disclosure may be implemented in practice.

### DETAILED DESCRIPTION OF THE EMBODIMENTS

Various apparatuses and processes will be described below to provide at least one example embodiment for the claimed subject matter. No embodiment described below limits any claimed subject matter and any claimed subject matter may cover apparatuses, devices or processes that differ from those described below. The claimed subject matter is not limited to the apparatuses, devices or processes having all of the features of any one apparatus, device or process described below, or to features common to multiple or all of the apparatuses, devices, or processes described below. It is possible that an apparatus, device or process described below is not an embodiment or implementation of any claimed subject matter. Any subject matter disclosed in an apparatus, device or process described below that is not claimed in this document may be the subject matter of another protective instrument, for example, a continuing patent application, and the applicants, inventors or owners do not intend to abandon, disclaim or dedicate to the public any such subject matter by its disclosure in this document.

### Terms and Definitions

The terms “vertical” and “horizontal” as used herein refer to positions relative to a reference plane such as the general surface of the earth. Unless expressly otherwise indicated, such a plane contains a certain feature of a rotary wing aircraft such as its longitudinal axis. In addition, a vertical axis is an axis extending up from the reference plane at 90 degrees with respect to the reference plane, and a horizontal axis is an axis running parallel to the reference plane.

Terms of degree such as “substantially”, “about”, “generally” and “approximately” as used herein mean a reasonable amount of deviation of the modified term such that the end result is not significantly changed. These terms of degree should be construed as including a deviation of the modified term if this deviation would not negate the meaning of the term it modifies.

The term “rotary wing”, as used herein, refers to a wing structure capable of rotating around an axis, thereby creating lift.

The term “substantially wingless” as used herein in connection with an aircraft means that the wings of the aircraft are insufficient to permit the aircraft to take off from a stationary position without the use of lift created by a rotary wing.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof

### General Implementation

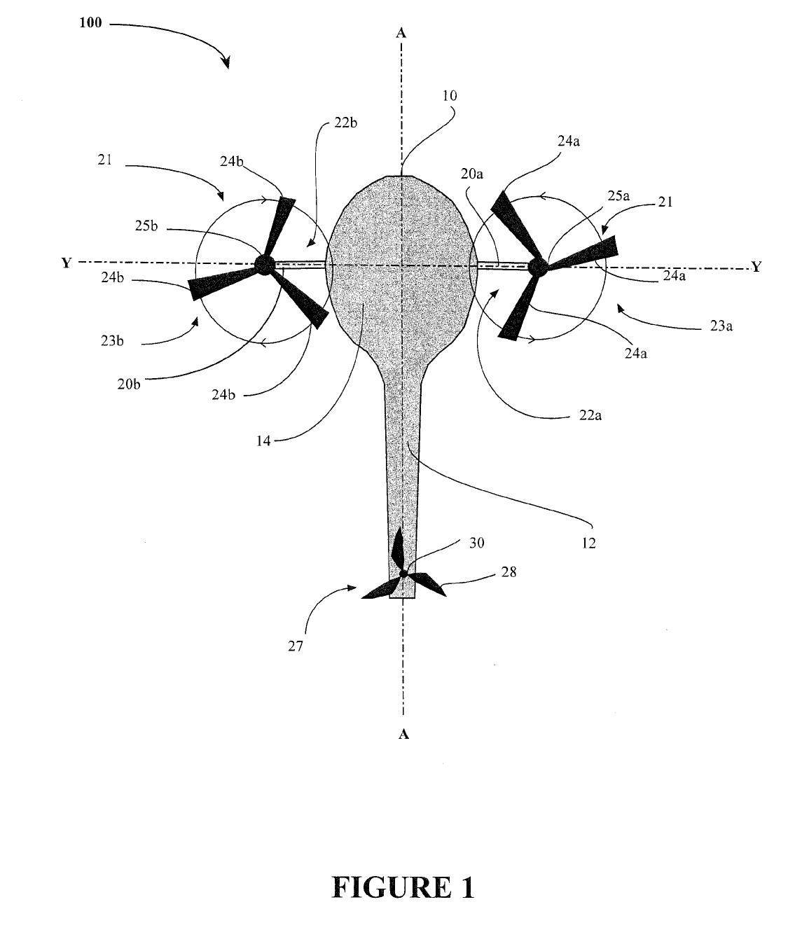

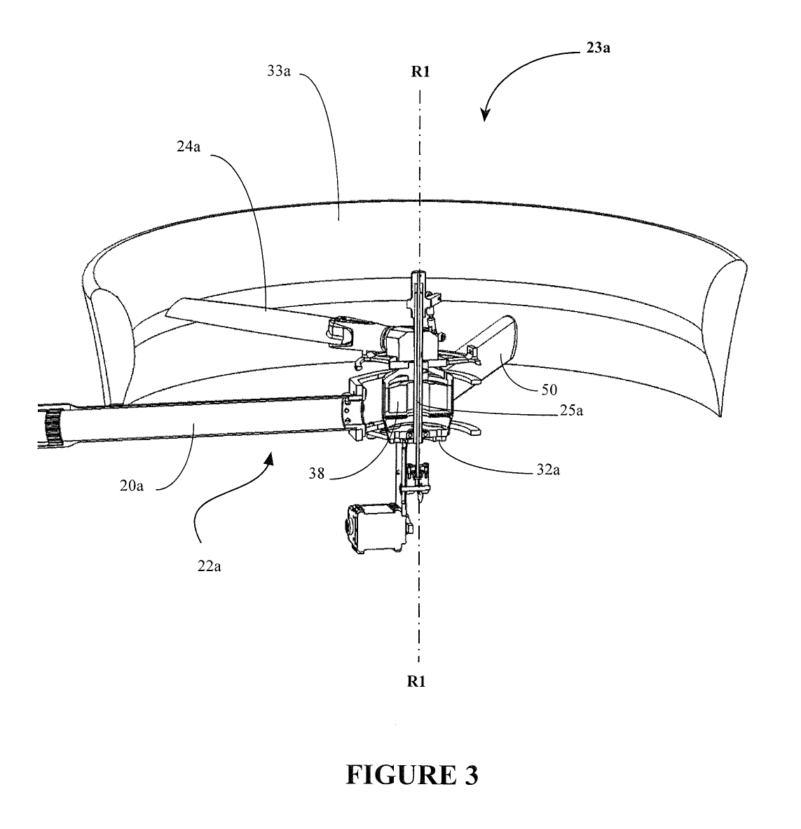

Referring now to FIG. 1, described therein is an overhead plan view of an example embodiment of a rotary wing aircraft 100. The aircraft 100 has a fuselage 14 having a front end 10, a mid-section that extends rearward along the longitudinal axis A and a rear end including a tail boom 12. A main rotor assembly 21 includes a first main rotor 23a and a second main rotor 23b equidistantly, or approximately equidistantly, positioned on either side of the fuselage 14 and connected thereto via first and second linkages 22a and 22b, that transversally extend along transversal axis Y from the fuselage 14 to support the first main rotor 23a and the second main rotor 23b, respectively. The first main rotor 23a has a first shaft 25a (as further shown in FIG. 3) from which rotor blades 24a radially extend. The rotor blades 24a rotate about a first rotational axis. Similarly, the second main rotor 23b has a second shaft 25b (not shown in FIG. 3, but identical to 25a, shown in FIG. 3) from which rotor blades 24b radially extend. The rotor blades 24b rotate about a second rotational axis.

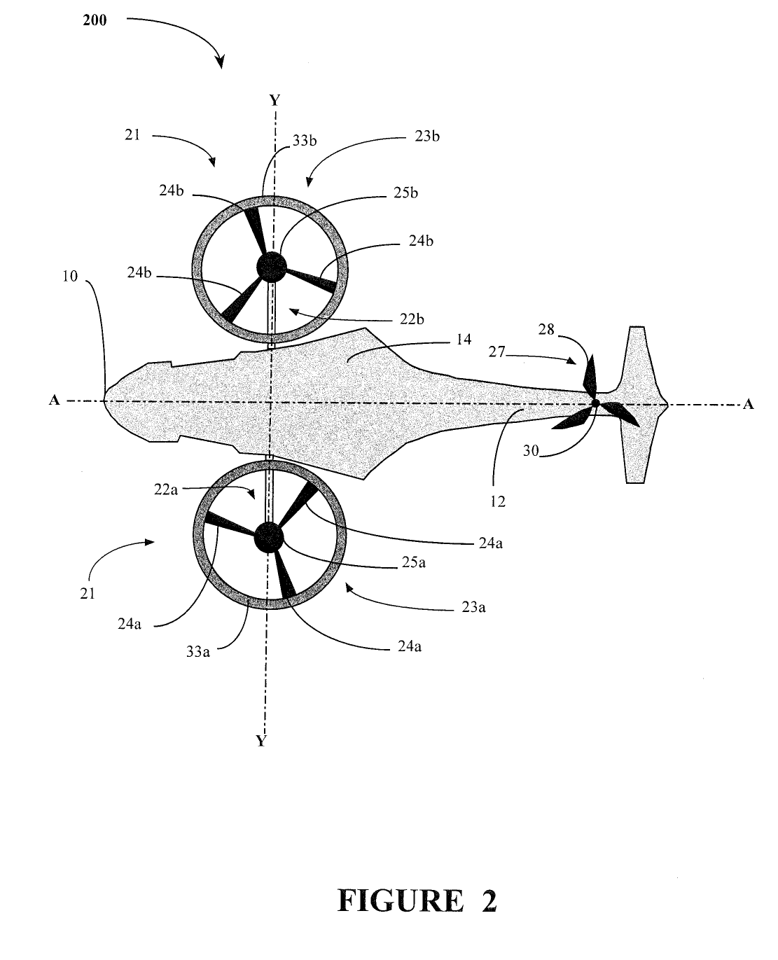

Referring now to FIG. 2, the present disclosure provides in another aspect, an example embodiment of a rotary wing aircraft 200. The aircraft 200 has a fuselage 14 having a front end 10, a mid-section that extends rearward along the longitudinal axis A and a rear end including a tail boom 12. A main rotor assembly 21 having a first main rotor 23a and a second main rotor 23b equidistantly, or approximately equidistally, positioned on either side of the fuselage 14 and connected thereto via first and second linkages 22a and 22b transversally extending from the fuselage 14 to support the first main rotor 23a and the second main rotor 23b, respectively. The first main rotor 23a has a first shaft 25a (as further shown in FIG. 3) from which rotor blades 24a radially extend. The rotor blades 24a rotate about a first rotational axis. Similarly, the second main rotor 23b has a second shaft 25b (not shown in FIG. 3, but identical to 25a) from which rotor blades 24b radially extend. The rotor blades 24b rotate about a second rotational axis. The rotary wing aircraft 200 further includes a first ring structure, referred herein as a ‘shroud’ 33a, and a second shroud 33b within which the first main rotor 23a and the second main rotor 23b, respectively, can freely rotate. In one embodiment, the shrouds 33a and 33b are constructed to be essentially coplanar with the plane of the rotor blades 24a and 24b. The shrouds 33a and 33b may provide one or more of the following of advantages: improved static thrust from the main rotor, in particular at speeds up to 200 knots; a reduction in propeller noise; and improved safety, notably reducing the risk of personal injury as a result of contact with a rotating rotor.

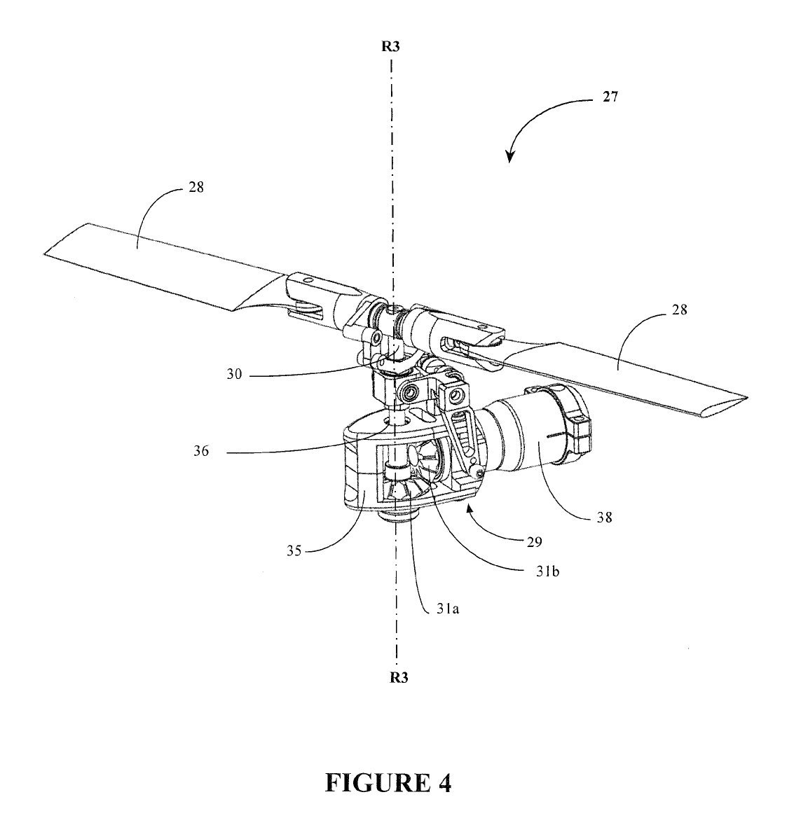

In some embodiments, the rotary wing aircrafts 100 and 200 may further comprise a tail propeller 27 coupled to the tail boom 12 by a third linkage and supported for rotation around a third rotational axis that is substantially vertical with respect to the horizontal plane containing the longitudinal axis of the fuselage. For example, in the embodiments shown in FIG. 1 and FIG. 2, the aircrafts 100 and 200, respectively, further comprise a tail propeller 27 that is rotatably connected via a linkage 29 to the tail boom 12 and has a shaft 30 from which tail blades 28 radially extend. The tail blades 28 rotate about a third rotational axis that is generally vertically positioned with respect to the horizontal plane including the longitudinal axis A of the aircrafts 100 and 200. It is noted that linkage 29 is not visible in FIG. 1 or 2, however an embodiment of a linkage 29 is shown in FIG. 4.

In another embodiment, the rotary wing aircraft of the present disclosure does not comprise the tail propeller 27.

Referring now to FIG. 3, shown therein is a cut away perspective view of an embodiment of a first linkage 22a for a first main rotor 23a. Although not separately shown, it will be understood that the present disclosure comprises a similar embodiment for a second linkage 22b for the main rotor 23b. The linkage 22a comprises a spar 20a and a rotor support structure 32a, attached thereto and a supporting shaft 25a, from which the rotor blades 24a radially extend, turning about the rotational axis R1. Further shown is a shroud 33a and a shroud linkage 50 connecting the shroud to the linkage 22a. In the embodiment shown in FIG. 3, the rotor support structure 32a is structured to house a servomotor 38, capable of powering the rotation of the shaft 25a. In other embodiments, a torque tube may be used to transmit rotational power from a power plant (not shown) positioned in the fuselage 14 to the shaft 25a, e.g. a torque tube extending from a tube end proximal to the fuselage 14 through the spar 20a to a tube end proximal to the shaft 25a, connected to the tube end proximal to the shaft 25a and having, in one embodiment, a beveled gear system, to implement rotation about axis R1. The beveled gear system may be similar to the beveled gear system hereinafter described with respect to the embodiment of the tail rotor shown in FIG. 4.

Referring now to FIG. 4, shown therein is a three dimensional perspective view of an embodiment of a third linkage 29 for a tail propeller 27 connecting the propeller 27 to the tail boom 12, and the shaft 30, from which the tail blades 28 radially extend, turning about the rotational axis R3. The linkage 29 in the embodiment shown in FIG. 4 includes a housing 35 having an aperture 36, of sufficient size for the shaft 30 to protrude and rotate within, and housing beveled gears 31a and 31b, angled relative to each other at 90 degrees. Beveled gear 31b is connected to the distal portion of a torque tube running through torque tube housing 38 and rotatably connected to a power plant (not shown). Beveled gear 31a is connected to the shaft 30. The linkage 29 and torque tube housing 38 may be connected to or positioned within a hollow tail boom 12.

Also shown in FIG. 4, rotational movement about axis R3 may be implemented via a torque tube extending through the tail boom 12, or in some other embodiments, a torque tube may substantially form the tail boom. In other embodiments, timing belt assemblies may be used instead to implement rotational axis R3.

In yet other embodiments, the tail propeller 27 may be powered by a servomotor in a manner similar to the embodiment shown for the main rotor in FIG. 3.

In one embodiment, the tail propeller 27 may be a single propeller system, mounted on top of the tail boom 12, for example, as shown in FIG. 1 and FIG. 2.

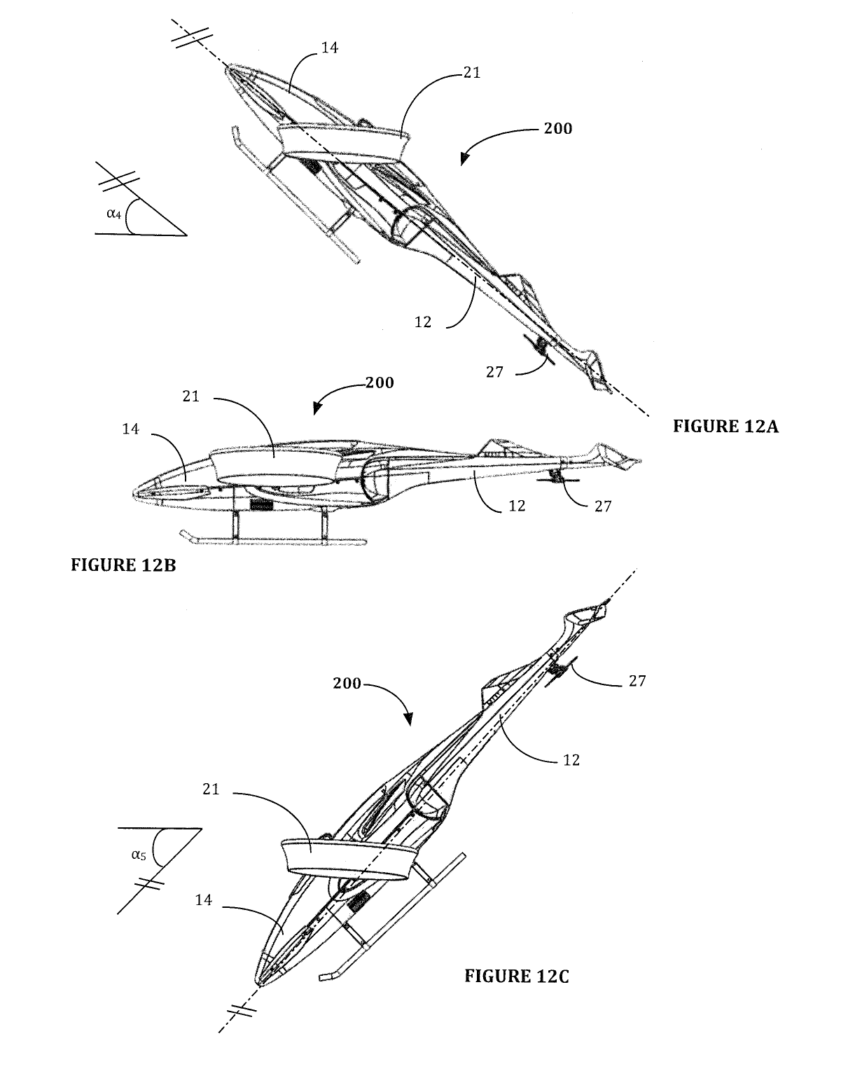

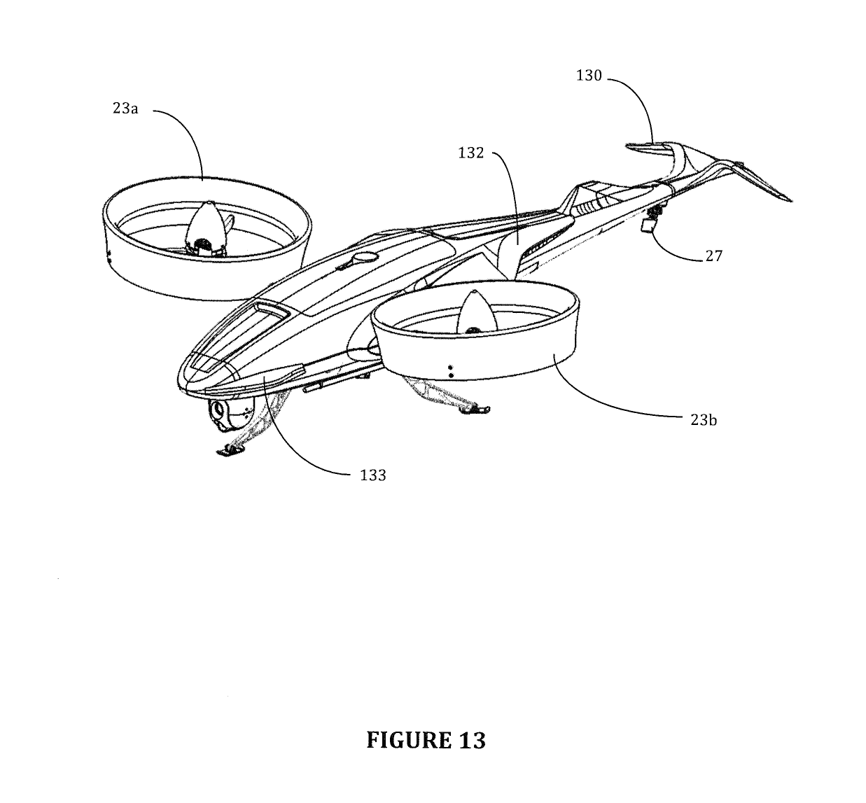

In another embodiment, the tail propeller 27 may be a single propeller system suspended from the bottom of the tail boom 12, for example as shown in FIGS. 12A-12C and FIG. 13.

It is an advantage of embodiments in which the propellers are mounted on top of the tail boom 12, that in such embodiments the tail propeller 27 is less likely to be impacted by the ground surface during landing and takeoff and maneuvers.

It is an advantage of embodiments in which tail propellers are suspended from the tail boom 12, that in such embodiments the airflow that is created by the tail propeller 27 is not obstructed by the tail boom 12, and thus more lift is generated.

In some other embodiments, the tail propeller system may comprise co-axial double rotors. This double propeller system may be used to reduce the undesirable effects of “reaction” and “gyroscopic” torque, by operating the two tail propellers in such a manner that they rotate in opposite directions. Co-axial propellers may be both mounted on top of the tail boom 12 or, in another embodiment, both suspended from the bottom of the tail boom 12, or one propeller may be mounted on top of the tail boom 12, and one propeller may be suspended from the bottom of the tail boom 12. The counter-turning blades generate thrusts along the same axis, as when using a single propeller by using left-hand and right-hand propellers.

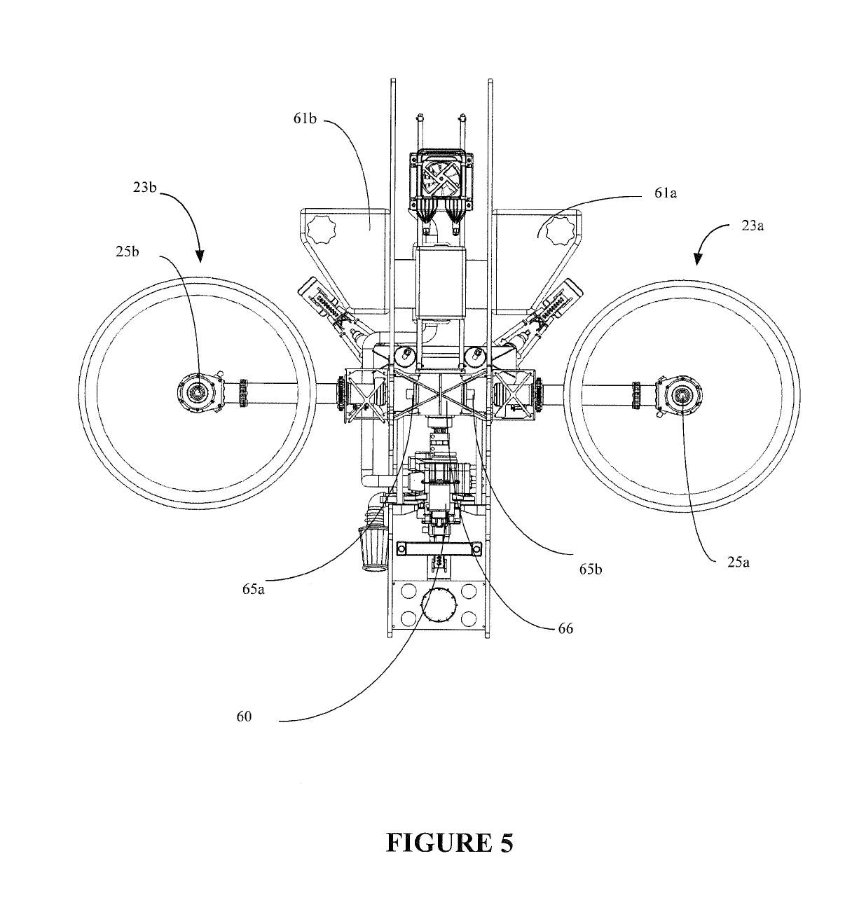

In some embodiments, the main rotors 23a and 23b may be operated by a single power plant that dependently or independently, via linkages, controls the rotational rate of the main rotors 23a and 23b. For example, as shown in FIG. 5, a single fuel driven power plant 60 receiving fuel from fuel tanks 61a and 61b connected to the power plant 60 via a fuel piping or hose system (not shown) may be used to drive rotation of first and second torque tubes 65a and 65b via a beveled gear system held in gear housing 66, and rotor shafts 25a and 25b.

In other embodiments, however, the main rotors 23a and 23b may each be driven by separate power plants, thus allowing for more separate control of the main rotors 23a and 23b. The power plants may be mounted in the fuselage 14, or included as a part of the main rotors 23a and 23b (as shown in FIG. 3).

The tail propeller 27 via linkages, for example torque tubes or timing belt assemblies, may be controlled by the same power plant as the main rotors, or by a separate tail propeller power plant, which may be mounted in the fuselage 14 or included as part of the tail propeller 27.

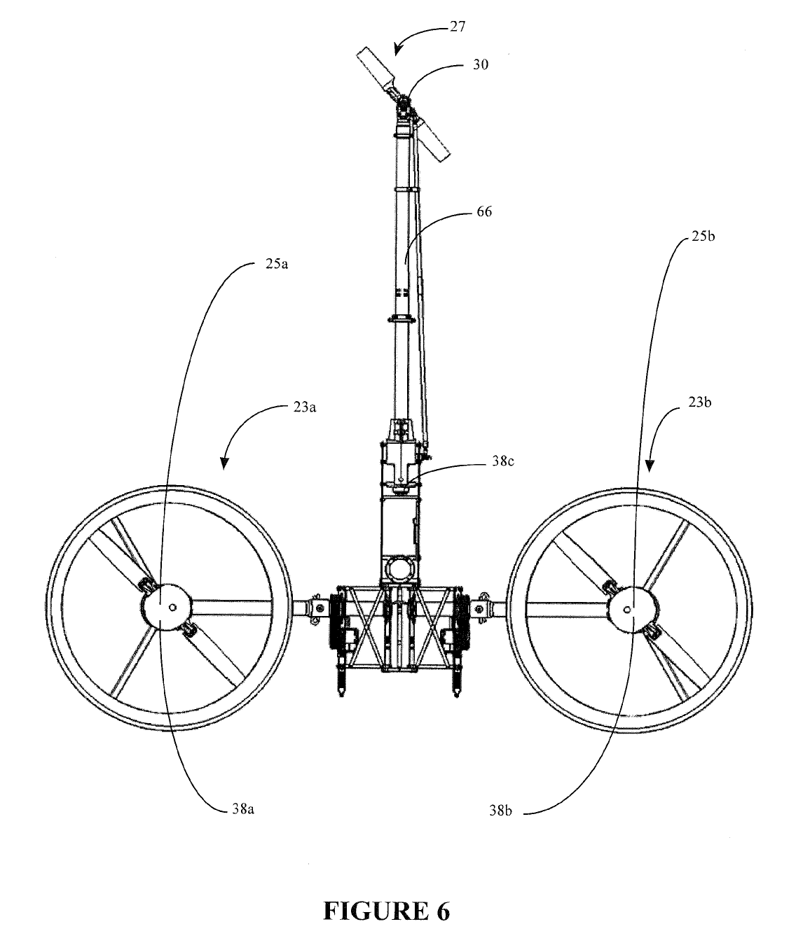

Referring now to FIG. 6, shown therein is another embodiment wherein each rotor is controlled by separate electric power plants. Shown in FIG. 6 are first, second and third electric power plants 38a, 38b and 38c, respectively, controlling rotation of shafts 25a and 25b (and thus the main rotors 23a and 23b) and the shaft 30 (and thus tail propeller 27), respectively. In this embodiment, power plant 38c is mounted centrally in the fuselage 14 and power is transferred to the shaft 30 via a torque tube 66. No torque tube is required for the transfer of rotational power to the shafts 25a and 25b.

In yet other embodiments, power may be provided by one or more fuel-electric hybrid power plants.

In some other embodiments, the main rotors 23a and 23b may be operated to rotate counter to each other, i.e. one of the main rotors 23a and 23b rotates in a clockwise direction, and the other of the main rotors 23a and 23b rotates in a counter clockwise direction. Such rotational direction is shown in FIG. 1 and FIG. 2. In this mode of operation the yaw motion of the aircraft may be minimized.

In another embodiment, the main rotors 23a and 23b may be operated to rotate in the same direction. In this mode of operation a yaw motion may exert force on the fuselage 14 to move against the motion of the rotor blades. In order to counteract such movement the tail boom 12 may be constructed to be sufficiently heavy and/or a tail rotor 27 is operated in a counter direction to provide enough reacting torque to balance the aircraft yaw motion induced by the main rotors 23a and 23b.

In one example embodiment, the rotational rate of the rotor blades 24a and 24b is varied, and by adjusting the rotational rate more or less lift is generated by the main rotors 23a and 23b.

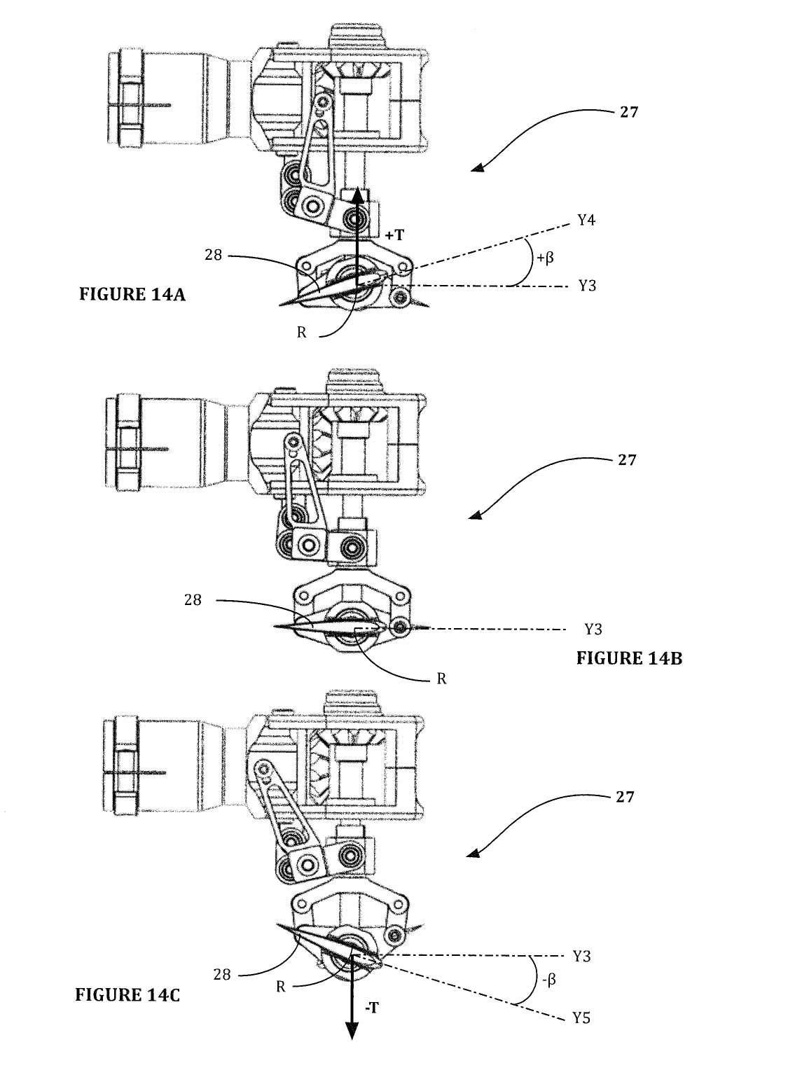

In another example embodiment, the rotational rate of the rotor blades 24a and 24b is constant, and the angle of attack of the rotor blades 24a and 24b is varied, thereby permitting the rotors 23a and 23b to generate more or less lift. Thus, in one mode of operation it is possible, for example, to operate the rotor at a certain constant maximum rotational rate and at a certain angle of attack, to generate maximum lift under these operating conditions, and then increase the angle of attack, thereby generating additional lift, allowing, for example, for a faster ascent of the aircraft. Operational adjustments that may be made with respect to the angle of attack of rotor blades are further shown in FIG. 14 and described below in reference to the tail propeller 27 and rotor blades 28 thereof. It will be clear to those of skill in the art that the described and shown principles apply similarly to the main rotors 23a and 23b and rotor blades 24a and 24b thereof.

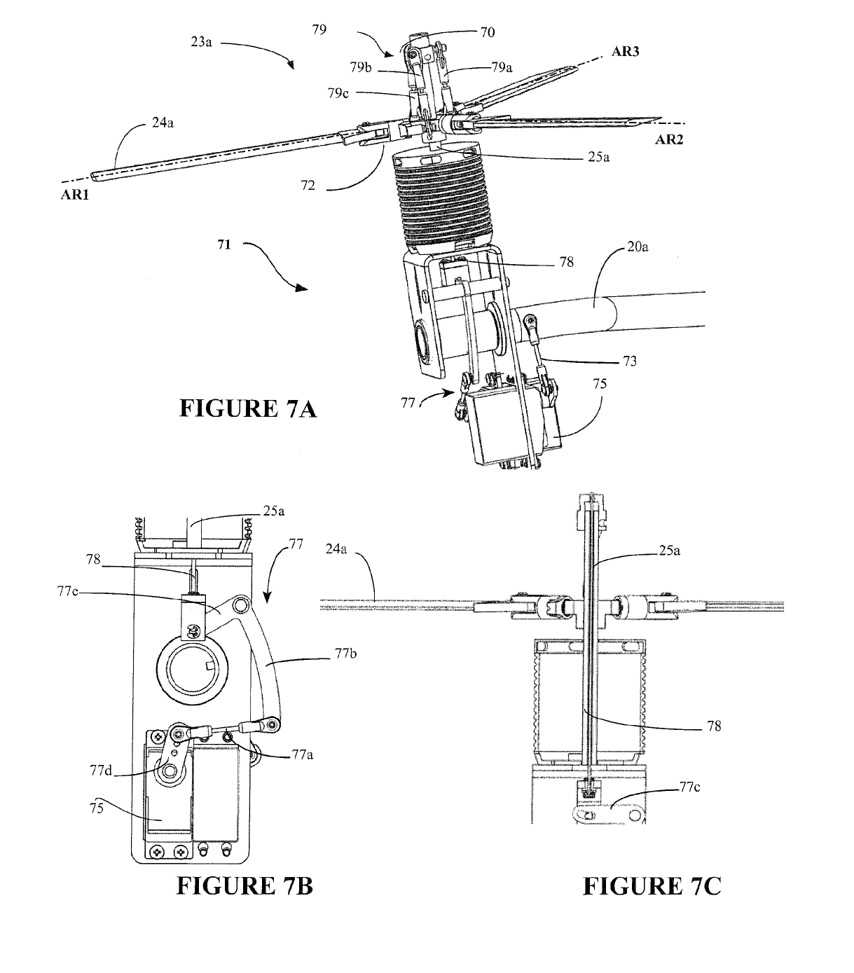

Referring to FIGS. 7A-7C now, described therein is an embodiment in which the angle of attack of the main rotor blades 24a of rotor 23a may be varied using a pitch assembly 71 permitting definition of the angle of attack of the rotor blades 24a. Although not separately shown, it will be understood that the present disclosure comprises a similar embodiment in which the angle of attack of rotor blades 24b of rotor 23b may be varied. In one embodiment, the pitch assembly 71 may be constructed using a slider 70 vertically moveable, along the motor rotating shaft 25a, thereby providing movement of the radially extending rotor blades 24a linked to rotatable rotor blade support structures 72. Rotation of the rotatable rotor blade support structures 72 permits rotation of the rotor blades 24a about their radially extending pitch angle axes AR1, AR2 and AR3, and definition of the angle of attack. The slider 70 is connected to the rotor blades 24a via a lever system 79, comprising one lever, 79a, 79b and 79c, for each rotor blade. The position of the slider 70 is controlled by a servomotor 75, through an arm assembly 77 comprising four rotatably connected arms 77a, 77b, 77c and 77d (FIG. 7B) (or in other embodiments 2, 3, 5, 6, 7 or more arms) connected to a push rod 78 in turn connected to the slider 70. The pitch assembly 71 is fixed to spar 20a and further support is provided by vertical stabilizer 73. Push rod 78 runs through (inside) the motor rotating shaft 25a sliding up and down to increase or decrease the pitch angle of the main rotor blades 24a (FIG. 7C). In other embodiments, the angle of attack may be controlled using other assemblies and control systems, e.g. gear or timing belt based assemblies or helicopter collective pitch assemblies.

In another example embodiment, both the rotational rate and the angle of attack of the rotor blades 24a and 24b may be varied, again as further illustrated below in reference to the tail propeller 27. One mode of operation in which it may be desirable to adjust both rotational rate and the angle of attack of the rotor blades may be when it is desirable to rapidly ascend (i.e. by increasing the rotational rate and the angle of attack) or rapidly descend (i.e. by decreasing the rotational rate and decreasing the angle of attack). Thus embodiments that allow control over the angle of attack and the rotational rate allow generally for more control over lift forces, and generally achieve a faster reacting aircraft.

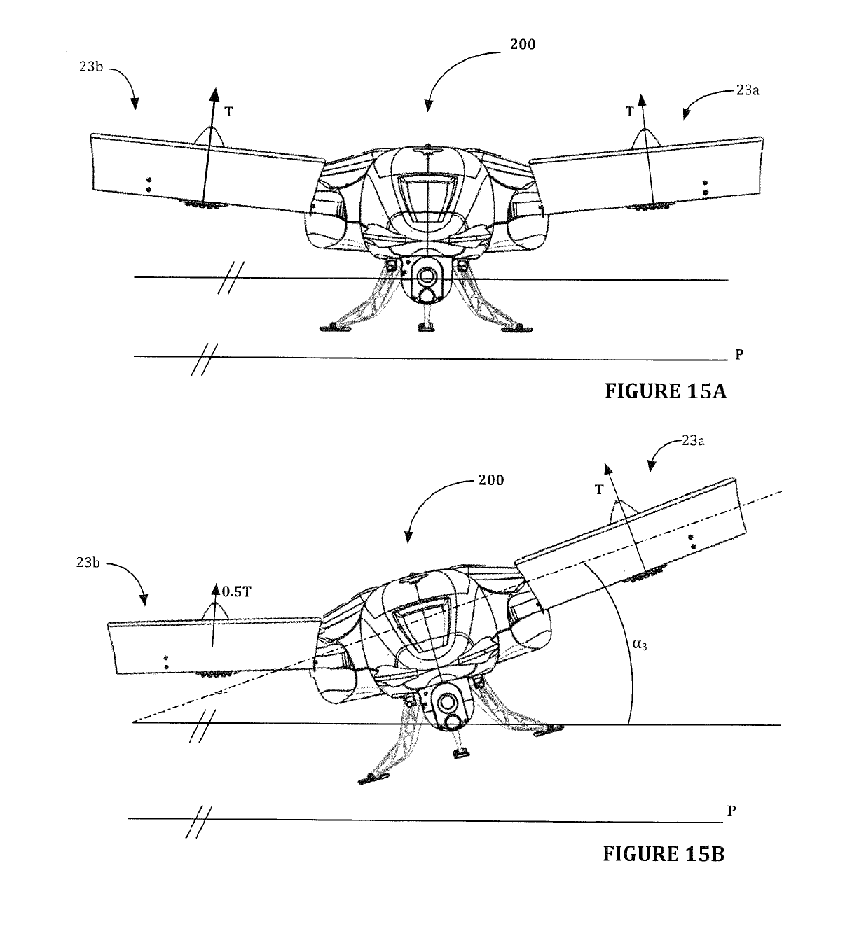

In some embodiments, the main rotors 23a and 23b may be operated independently from one another, i.e. rotational rate and/or the angle of attack of the rotor blades 25a and 25b may be independently adjusted. Thus, the aircraft may be operated in a manner that results in rotor 23a and 23b not providing identical lift. This generally results in a rotation of the aircraft about the longitudinal axis A (see FIG. 1 or FIG. 2). Thus, referring now to FIG. 15A, for example, when the aircraft is operated to provide a thrust T by rotor 23a which is equal to a thrust T provided by rotor 23b, the aircraft 200 will remain positioned parallel to a plane P, as shown in FIG. 15A. When the aircraft is operated to provide a thrust T by rotor 23a and to provide a thrust less than T, e.g. thrust 0.5 T, by rotor 23b, the aircraft 200 will tilt at an angle as relative to the plane P as shown in FIG. 15B.

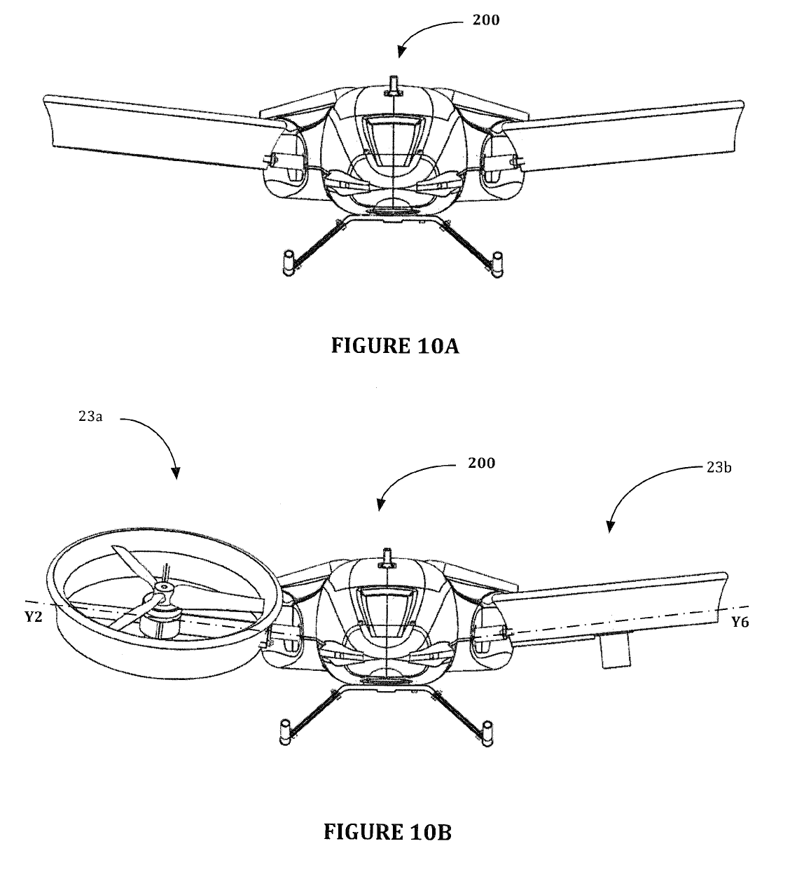

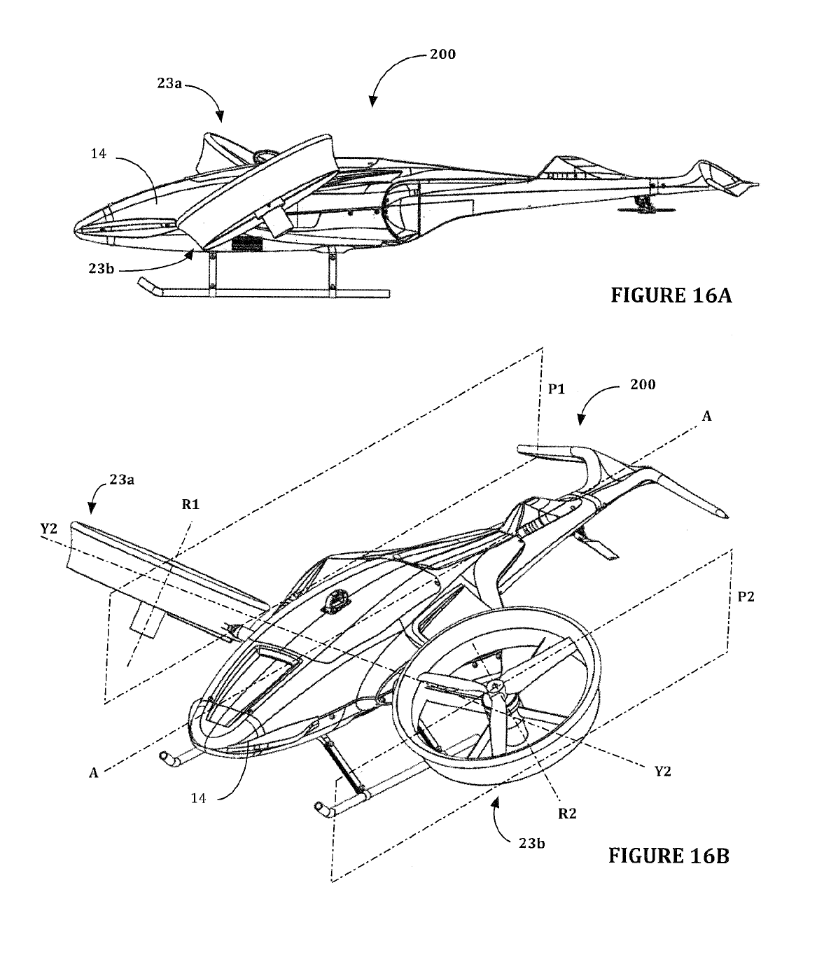

In some embodiments, lift by the main rotors 23a and 23b may further be adjusted by rotating the rotors 23a and 23b around an axis Y2 and Y6 respectively, (e.g. as shown in FIGS. 10A-10B and FIGS. 16A-16B), as hereinafter described.

In other embodiments of the aircraft having a tail propeller 27, the rotational rate of the tail propeller blades 28 may be varied, and by adjusting the rotational rate more or less lift is generated by the tail propeller 27.

In further embodiments, the rotational rate of the tail propeller blades 28 may remain constant, while the angle of attack of the tail propeller blades 28 is varied, thereby permitting the tail propeller 27 to generate more or less lift.

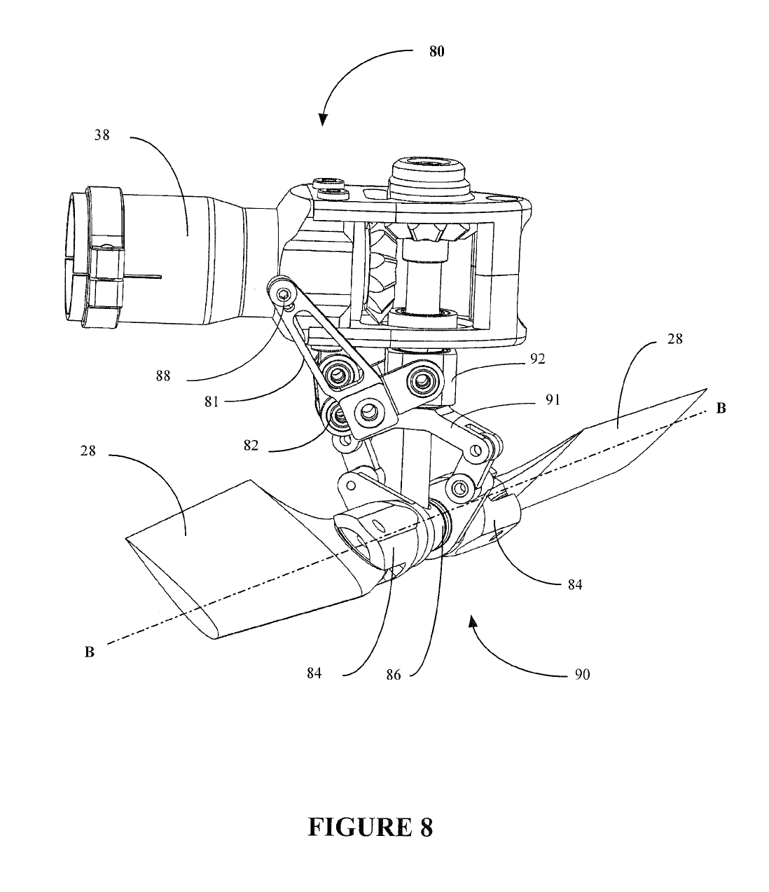

Referring now to FIG. 8, shown therein is an example embodiment of a tail propeller assembly 80, where the angle of attack of the tail propeller blades 28 is varied using a pitch assembly 90 permitting definition of the angle of attack of the rotor blades 28. Tail rotor adjustment, in one embodiment, may be achieved using a push rod (not shown), which may be extended through the tail, and of which horizontal movement may be controlled by a servomotor (not shown). Movement towards the tail of a push rod linked to push rod linkage point 88 on L-shaped arm 81, which is stabilized by vertical stabilizer 82, effects vertical downward movement of collar 92. Such downward pressure pushes the tail pitch control links 91 to rotate tail rotor holders 84, which hold and rotate the tail propeller blades 28 about the axis B.

Rotation of the tail propeller blades 28 about axis B, results in alteration of the angle of attack of the propeller blades 28, as further illustrated in FIGS. 14A-14C. Referring now to FIGS. 14A-14C, shown therein are example embodiments of a tail propeller 27, in which the angle of attack, p, defined by a first horizontal axis Y3 and a second axis Y4 or Y5 intersecting with Y3 at the rotational point R coinciding with axis B (FIG. 8), is varied. FIG. 14A shows an angle of attack of +β providing a vertically upwards directed thrust +T, FIG. 14B shows an angle of attack of 0 generating a thrust of 0, and FIG. 14C shows an angle of attack of −β providing a vertically downwards thrust −T. Thus, by rotation about axis B, the propeller blades 28 may be positioned to vary the angles of attack across a wide range of operationally selected angles, which may vary in some embodiments, for example, from between +30° to −30°.

In another example embodiment, both the rotational rate and the angle of attack of the propeller blades may be varied. Generally embodiments that allow control over the angle of attack and the rotational rate allow generally for more control over lift forces.

By varying the lift generated by the tail propeller 27 (either by alteration of the rotational rate or the angle of attack or both), the tail boom 12 may be lifted up or down relative to the front end 10 of the fuselage 14. Similarly, by varying the lift generated by the main rotors 23a and 23b (either by alteration of the rotational rate or the angle of attack or both), the front end 10 or the fuselage may be lifted up or down relative to the tail boom 12. Thus, by varying the relative amount of lift generated by the tail propeller 27 and the main rotors 23a and 23b, the aircraft may be positioned while in the air at various angles as hereinafter further described and shown in FIGS. 12A-12C.

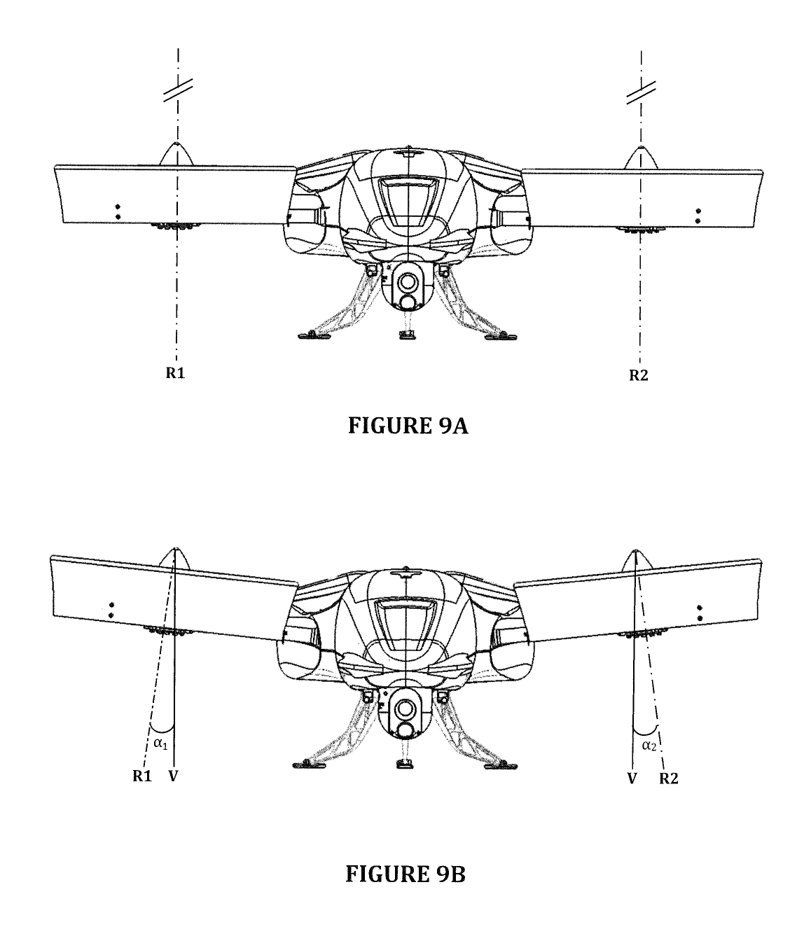

In one embodiment provided herein, the first and second linkages are constructed so that first and second rotational axes are angled out of a vertical plane running parallel (i.e. spaced apart) with respect to the vertical plane through longitudinal axis A of the fuselage. Referring now to FIGS. 9A-9B, shown therein are example embodiments of an aircraft wherein the main rotors 23a and 23b are linked to the fuselage rotated at different angles out of a vertical plane running parallel with respect to and spaced apart from the vertical plane running longitudinal axis A of the fuselage 14 of the aircraft. As shown in FIG. 9A, the first rotational axis R1 and the second rotational axis R2 may be positioned parallel to one another in the same vertical plane, such that both of the rotational axes R1 and R2 may be vertically positioned and a vertical plane containing the longitudinal axis A of the fuselage 14 of the aircraft (e.g. as shown in FIG. 1) is positioned parallel with respect to and spaced apart from each of the parallel vertical planes containing the first rotational axis R1 or the second rotational axis R2.

Referring further now to FIGS. 9A-9B, in other embodiments, the main rotors 23a and 23b are mounted using a linkage such that the planes containing the first and second rotational axes R1 and R2 are angled out of a vertical plane running parallel with respect to and spaced apart from the vertical plane containing the longitudinal axis A of the fuselage 14. In general, the angle at which the rotational axis is positioned with respect to the vertical plane containing the longitudinal axis A may be relatively modest so that the angle between the axis R1 or R2 of the main rotor and the longitudinal axis A of the fuselage 14 may be preferably less than ±6-10 degrees. As further shown in FIG. 9B the angle referred to is the angle α₁ or α₂ between a line V vertically projected down from the top of the shafts 25a and 25b and lines projected down at an angle centrally through the rotational axis R1 or R2 of the shafts 25a and 25b. It is further noted that in the foregoing embodiment, each main rotor may be rotatable about a separate non-co-planar transversal axis, as shown in FIG. 10B, wherein main rotor 23a can be seen to have a transversal axis Y2, and main rotor 23b can be seen to have a transversal axis Y6, about which rotors 23a and 23b may be rotatable.

In a further embodiment, the rotary wing aircraft comprises first and second linkages that are moveable so that the first and second rotational axes pivot out of a vertical plane running through the axes and is parallel to and spaced apart from a vertical plane through the longitudinal axis A of the fuselage 14. For example, referring to FIGS. 9A-9B, the rotational axes are moveable from the angles α₁ and α₂ (FIG. 9B), to the vertical position of the axes shown in FIG. 9A.

In a further embodiment, the rotary wing aircraft comprises first and second linkages that are independently moveable, so that the first and second rotational axes pivot out of a vertical plane running through the axes and is parallel to and spaced apart from a vertical plane through the longitudinal axis A of the fuselage 14. For example, referring to FIGS. 9A-9B, the rotational axes are independently moveable from the angles α₁ or α₂ (FIG. 9B), to the vertical position of the axes shown in FIG. 9A.

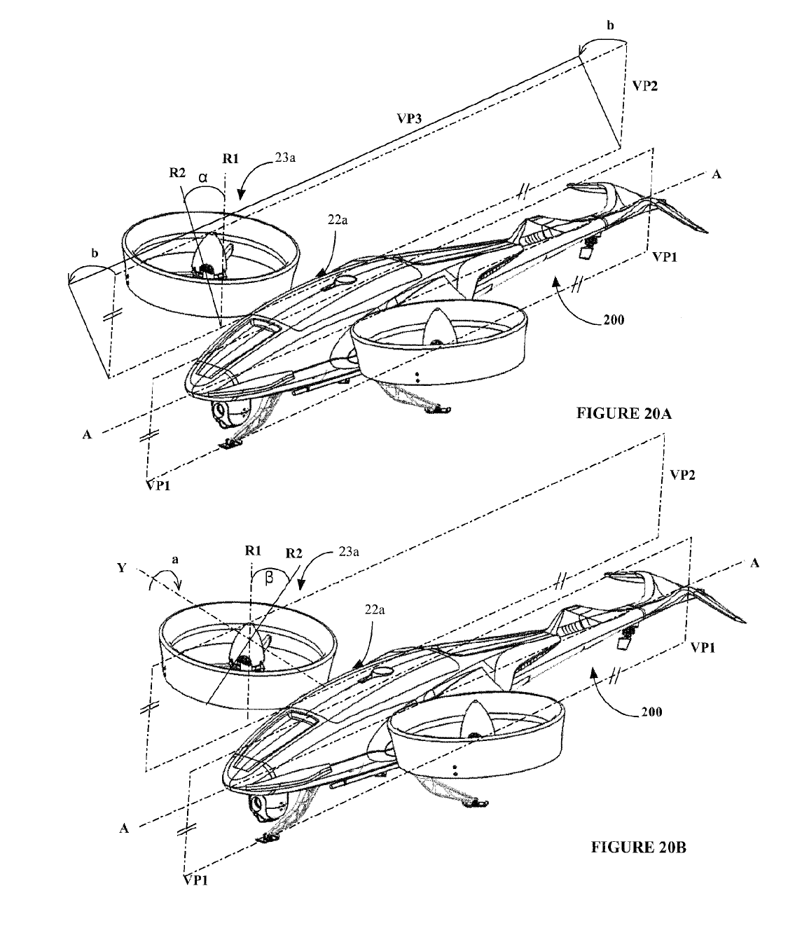

Referring now to FIG. 20A, shown therein, for further clarity, is a rotary wing aircraft 200 and a longitudinal axis A and vertical plane VP1 through longitudinal axis A. Vertical plane VP2 is a vertical plane parallel to the vertical plane VP1 and vertical plane VP2 is a vertical plane spaced away in transversal direction from VP1. Movement of linkage 22a results in movement out of vertical plane VP2 of the rotational axis R1 of the rotor 23a. In particular, as illustrated, by way of example, in FIG. 20A movement of linkage 22a can result in a pivoting movement of the rotational axis R1 across angle α, and a pivoting movement of the rotor 23a towards a rotor position corresponding with R2. This represents a movement of rotational axis R1 out of vertical plane VP2 into vertical plane VP3, as further indicated by directional arrow b.

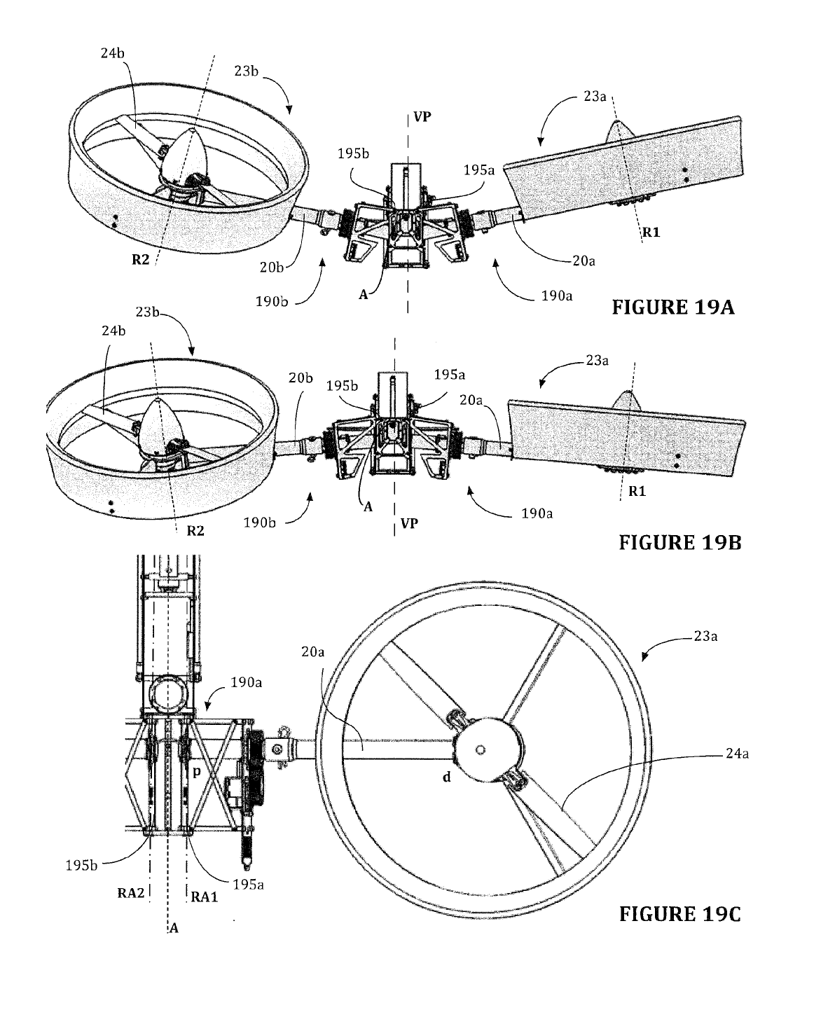

Various linkage constructions are possible to achieve pivoting of the rotors 23a and 23b. One example embodiment of a linkage 22a is shown in FIGS. 19A-19C. Referring to FIGS. 19A-19C, shown therein are rotors 23a and 23b having a rotational axis R1 and R2, respectively. The linkages 190a and 190b comprising spars 20a and 20b, respectively, transversally extend from a fuselage that has a longitudinal axis A. A distal portion (d) of the spars 20a and 20b is connected to the rotors 23a and 23b, respectively. A proximal portion (p) of the spars 20a and 20b is connected to longitudinally extending rotatable connecting rods 195a and 195b, respectively, that have a rotational axis RA1 and RA2 respectively, each parallel and spaced apart from the longitudinal axis A of the fuselage. The connecting rods 195a and 195b can be rotated about rotational axes RA1 and RA2, respectively. Rotation of the connecting rods 195a and 195b permits pivoting of the first and second rotors 23a and 23b, as well as pivoting of the rotational axes, R1 and R2, at different angles out of a vertical plane that is parallel to and spaced apart from the vertical plane (VP) of the longitudinal axis of the fuselage. In preferred embodiments, the angle between the main rotors 23a and 23b and the longitudinal axis A of the fuselage is less than ±45 degrees. In more preferred embodiments, the angle between the main rotors 23a and 23b and the longitudinal axis A of the fuselage is less than ±6-10 degrees. As used herein a positive angle (e.g. +6 degrees), is an angle wherein the rotational axes of the left and right rotor, if sufficiently extended, intersect at a point above the fuselage, whereas a negative angle (−6 degrees), is an angle wherein the rotational axes of the left and right rotor, if sufficiently extended, intersect at a point below the fuselage. As further shown in FIG. 9B the angle referred to is the angle α₁ or α₂ between a line V vertically projected down from the top of the shafts 25a and 25b and lines projected down at an angle centrally through the rotational axis R1 or R2 of the shafts 25a and 25b.

In some embodiments, the first and second main rotors 23a and 23b may be positioned such that their rotational axes R1 and R2 may be positioned parallel to one another in a vertical position.

In other embodiments, the rotary wing aircraft may be constructed using a linkage that is moveable so that the first rotational axis R1 and the second rotational axis R2 rotate in a vertical plane running parallel with respect to the vertical plane through the longitudinal axis of the fuselage. Such linkage permits rotation of the main rotors 23a and 23b about the transversally extending axis Y, shown in e.g. FIG. 1 and FIG. 2, and thus, it will be clear that in such embodiment, the rotors 23a and 23b are rotatable in a plane containing axis R1 or R2 parallel to and spaced apart from a vertical plane containing the longitudinal axis A of the fuselage. Referring further to FIG. 16B, shown therein is an aircraft 200, in which the rotors 23a and 23b are rotatable about transversally extending axis Y in planes P1 and P2, respectively, containing axes R1 and R2, respectively, parallel to a plane containing longitudinal axis A of the fuselage 14.

In one embodiment, the angles of the first rotational axis R1 and the second rotational axis R2 with respect to the vertical plane of the longitudinal axis A of the fuselage may jointly be altered in a vertical plane that runs parallel to and is spaced apart from the vertical plane of the longitudinal axis A. For example, the rotation may result in the first and the second rotational axes R1 and R2, respectively, remaining positioned in the same horizontal plane (see: FIG. 10A).

In other embodiments, the first and second main rotors 23a and 23b may be rotated in such a manner that the angle of first rotational axis R1 and the angle of the second rotational axis R2 with respect to the vertical plane containing the longitudinal axis A of the fuselage 14 may be altered independently of one another in a vertical plane running parallel to and spaced apart from the vertical plane of the longitudinal axis A. Such independent alteration may result in the first and second rotational axes R1 and R2 diverting from a parallel or co-planar position. An example of non-parallel positioning of the main rotors 23a and 23b is illustrated in FIG. 10B.

In some embodiments, the rotation about axis Y of the rotors 23a and 23b that may be achieved is 360 degrees, i.e. the aircraft can be operated so that the rotors can be positioned at every possible angle about axis Y. In other embodiments, the linkages provide more limited e.g. between +90 and −90 degrees, or, +60 and −60 degrees between +45 and −45 degrees. In general, the more degrees of rotation are provided for the more in air control options are attained.

Referring now to FIG. 20B, shown therein, for further clarity, is a rotary wing aircraft 200 and a longitudinal axis A and vertical plane VP1 through longitudinal axis A. Vertical plane VP2 is a vertical plane parallel to the vertical plane VP1 and vertical plane VP2 is a vertical plane spaced away in transversal direction from VP1. Movement of linkage 22a results in rotational movement of the axis R1 of rotor 23a around axis Y, within vertical plane VP2, as indicated by directional arrow a. Such rotational movement of rotational axis R1 may occur for example across an angle β resulting in a rotor position corresponding with rotational axis R2.

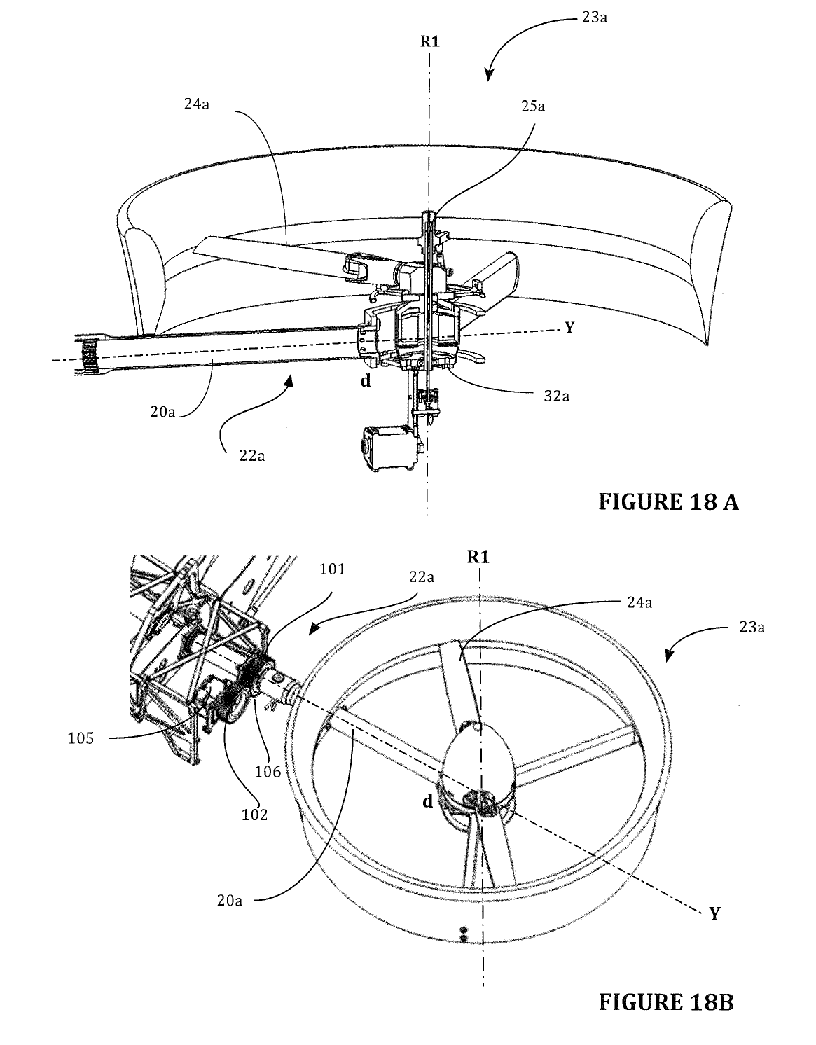

Various linkage constructions are possible to achieve rotation of the rotors 23a and 23b about transversally extending axis Y. One example embodiment of a linkage 22a is shown in FIGS. 18A-18B. Referring now to FIGS. 18A-18B, shown therein is rotor 23a having a rotational axis R1. The linkage 22a comprises a spar 20a transversally extending from the fuselage (not shown) and a rotor support structure 32a that is attached to a distal end d of the spar 20a. A supporting shaft 25a, having radially extending rotor blades 24a attached thereto can freely turn about its axis thus permitting rotation of the rotor 23a about rotational axis R1 within the rotational support structure 32a. The spar 20a and the attached rotor support structure 32a can further be turned about transversally extending rotational axis Y resulting in a rotation of the shaft at different angles in a vertical plane that is parallel to and spaced apart from the vertical plane of the longitudinal axis of the fuselage (not shown). Rotation about transversally extending axis Y is controlled by a servomotor 105 and gear assembly 106 comprising gears 101 and 102 capable of rotating the spar about transversally extending axis Y. It will be understood that a counterpart linkage extending transversally from the fuselage in opposite direction may be constructed for rotor 23b (not shown).

Rotation about axis Y (see: FIGS. 10A-10B), results in an adjustment of the angle of thrust. Referring now to FIGS. 16A-16B, shown therein is a side view and an angled view of an aircraft 200 and main rotors 23a and 23b. By rotating the rotor about axis Y, the direction of the thrust is altered, thus providing for lateral (forward or backward) movement of the aircraft when a rotor is moved from a position parallel with plane P.

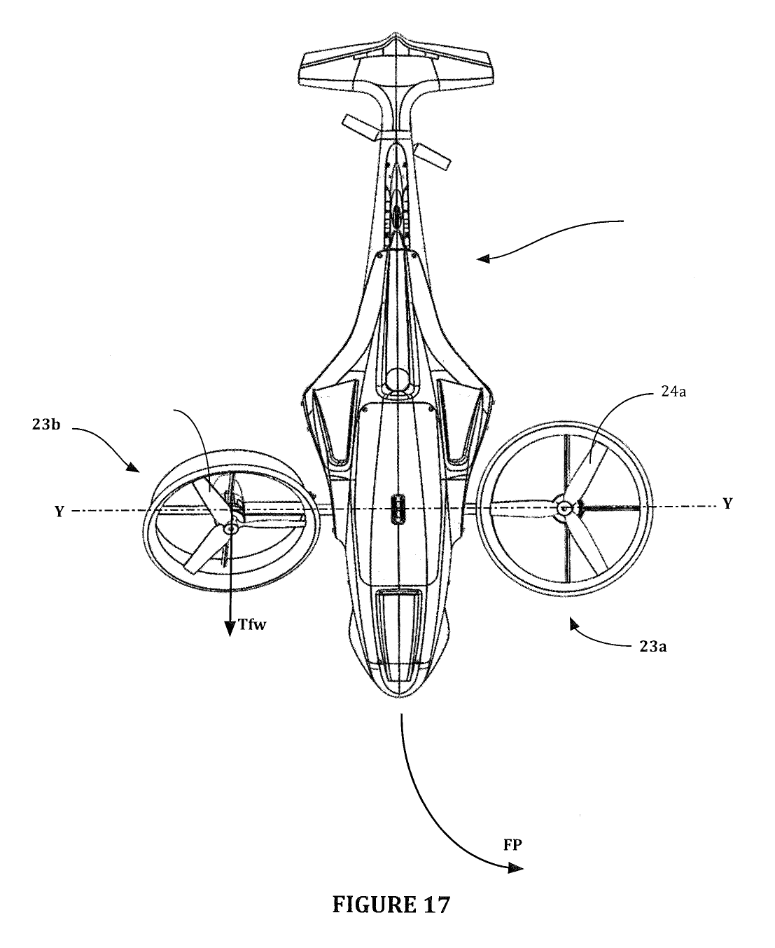

As hereinbefore described, in some embodiments, the rotors 23a and 23b can be independently rotated around axis Y. This provides for the ability to generate differential forward thrust by the two rotors, and a change in the lateral direction in which the aircraft is moving. Thus, referring now to FIG. 17, rotor 23a provides substantially only upward thrust and vertical lift, while rotor 23b, which is located in a different rotational position relative to axis Y, provides a combination of upward thrust and forward thrust Tfw. Assuming the two rotors 23a and 23b are operated at substantially equal rotational rates and the angle of attack of the blades 25a and 25b is substantially identical the aircraft will be directed as generally indicated by the flight path FP.

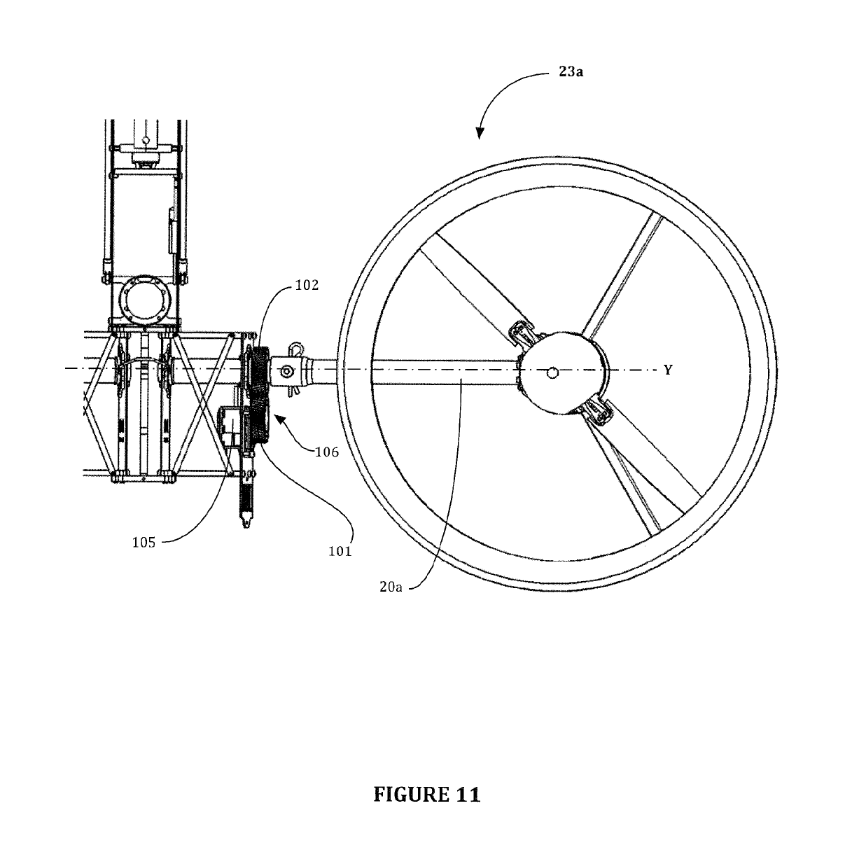

Referring to FIG. 11, shown therein is a diagram of an example embodiment of a linkage which permits rotation of the main rotor 23a about the axis Y controlled via a gear assembly 106 comprising gears 101 and 102 controlled by an independent servomotor 105 connected to gears 101 and 102, wherein output gear 102 is circumferentially attached to spar 20a, and input gear 101 is rotatably connected to servomotor 105 allowing for rotational control and movement of spar 20a about axis Y. In other embodiments other gear assemblies may be used such as a sprocket-chain assembly, a timing belt assembly or a 4-bar assembly, all of which are capable of effecting rotational control of the main rotors about axis Y. Although not separately shown, it will be understood that the present disclosure comprises a similar embodiment in which the angles of main rotor 23b may be controlled.

While the primary purpose of the main rotor assembly 21 is to provide lift and thrust for the aircraft, the primary purpose of the tail propeller 27 is to control the angle at which the fuselage 14 is positioned in flight relative to a general horizontal earth surface. In one operational procedure, the tail propeller 27 may be operated to create more lift, so that the tail boom 12 is raised relative to the front 10 of the fuselage 14 as shown in FIG. 12C. This may be achieved by increasing the rotational rate of the tail propeller 27 or by adjusting the angle of attack (as shown in FIGS. 14A-14B), or a combination thereof. In another operational procedure, the tail propeller 27 may be operated to create less lift (or negative lift pushing the tail downward), so that the tail boom 12 is lowered relative to the front 10 of the fuselage 14 as shown in FIG. 12A. This may be achieved by decreasing the rotational rate of the tail propeller 27 or by adjusting the angle of attack (as shown in FIGS. 14B-14C), or a combination thereof. Thus the angle of flight of the rotary wing aircraft of the present disclosure may be tightly controlled through the tail propeller.

The aircraft of the present disclosure may be operated to fly at a range of horizontal speeds or hover in essentially a horizontal (0 degrees) position, as shown in FIG. 12B, or to fly or hover in a tilted or pitched position as shown in FIG. 12A and FIG. 12C. Thus, a pilot may operate the rotary wing aircraft in such a manner that the fuselage 14 is tilted at different degrees with respect to a horizontal reference plane. For example, this tilt angle may be +10 degrees; +20 degrees, +30 degrees, +45 degrees +60 degrees, or +80 degrees, or this tilt angle may be −10 degrees, −20 degrees, −30 degrees, −45 degrees −60 degrees or −80 degrees relative to a reference plane, wherein the positive sign signifies that the nose of the rotary wing aircraft is pitched up in position relative to the tail boom 12 (see FIG. 12A) and a negative sign signifies that the nose of the rotary wing aircraft is pitched down in position relative to the tail boom 12 (see FIG. 12C), notably FIG. 12A illustrates an example tilt angle α₄ of approximately +45 degrees, FIG. 12B shows an example tilt angle of 0 degrees, and FIG. 12C illustrates an example tilt angle α₅ of approximately −45 degrees.

In some embodiments, the aircraft may be operated to perform inverted hover maneuvers at various pitch angles (not shown), by generating tilt angles beyond 90 degrees.

It is noted that conventional helicopters are generally able to perform hover maneuvers at a limited amount of tilt angles, as they are unable to achieve tilt angle in excess of ±10 degrees. Furthermore, conventional helicopters are generally able to hover only when positioned horizontally, and not when positioned in a tilted position. Instead when conventional helicopters are tilted, they tend to move forward/backward. By contrast, the aircraft described herein may hover while in tilted positions at various angles, for example in excess of ±10 degrees, ±20 degrees, ±30 degrees, +45 degrees ±60 degrees, or ±80 degrees when in tilted positions (such as e.g. shown in FIGS. 12A and 12 C), by operating the main rotors in conjunction with the tail rotor to provide only upward lift and eliminating forward/backward thrust. This feature of the aircraft of the present disclosure facilitates landing on or departing from non-horizontal, sloped terrain, including a sloped static surface, or a sloped dynamic surface, e.g. on a vessel in moving water.

Thus in general, by balancing the lift and forward/backward thrust generated by the main rotors, and the tail propeller, as the case may be, through control and definition of a combination of rotor and tail propeller rotational rates, the angle of attack of the main rotor blades and the tail propeller blades, and the rotational position of the main rotors, the aircraft of the present disclosure may be operated to hover in any tilted position, and from such hovering position may move in all three dimensions in all six degrees of freedom (i.e. forward/backward, lateral to the left/lateral to the right, vertically up/down, roll clockwise/counter-clockwise rotation, pitch clockwise/counter-clockwise rotation, and yaw clockwise/counter-clockwise rotation), by adjusting the rotational rates, the angle of attack of the main rotor and tail propeller blades, and/or the rotational position of the main rotors.

In other embodiments, the rotary wing aircraft may be capable of landing on surfaces that may be considered non-horizontal such as slopes, for example, in mountainous terrain, or surfaces angled at more than ±6 degrees, or more than ±10 degrees, or more than ±15 degrees or more than ±20 degrees or more than ±30 degrees or more than ±40 degrees, relative to a general horizontal earth surface. Thus, by way of example, an aircraft hovering in the horizontal position depicted in FIG. 12B above a surface having an angle α₄, may be landing on such surface. This may be accomplished operationally by first decreasing the angle of attack and/or the rotational rate of the tail rotor and/or increasing the angle of attack and/or rotational rate of the main rotor to tilt the aircraft upwards, while simultaneously gradually adjusting the rotational position of the main rotors, by linkage to rotate the main rotor about the transversal axis Y (as depicted in e.g. FIG. 11), until the aircraft is hovering above the surface in the position depicted in FIG. 12A. The aircraft may then land on the surface having angle α₄ by gradually decreasing the rotor speed of the main rotors and/or by decreasing the angle of attack of the rotor blades of the main rotor, gradually reducing lift until the aircraft lands.

In further example operations, the aircraft may even be perched against vertical walls or even against ceilings, again through control and definition of a combination of rotor and tail propeller rotational rates, the angle of attack of the main rotor blades and tail propeller blades, and the rotational position of the main rotors.

The present disclosure provides in at least one embodiment a rotary wing aircraft having improved flight control and stability to the aircraft. Thus, for example, the tail propeller may be used to adjust tail thrust for example when the aircraft becomes sub-optimally balanced. The deviation from optimal balance may be detected by the aircraft pilot, or, in some embodiments, by an automated electronic sensing and control system capable of detecting and monitoring the aircraft's position and adjusting the position when deviations from set standards are detected, such as a gyroscope based systems, of micro electric mechanical system (MEMS) type systems comprising an accelerometer, such as used for example in hobby helicopters, or other systems capable of creating a signal and response as a result of aircraft pitch, roll and yaw motions. Thus, for example, the tail thrust may be adjusted in response to cargo in the aircraft having shifted, fuel being consumed, presence of external disturbances (e.g. wind disturbances, collisions or proximity to obstacles, such as trees, buildings, towers and the like) or when mission specific sensors such as camera gimbals, gas sniffers, and other sensors are swapped or repositioned for enhanced data capture, for example, within the aircraft's fuselage. In one example operational procedure, when cargo shifts towards the tail end of the aircraft, the tail boom may drop putting the aircraft in an upward pitched position, as may be detected by the pilot or an electronic system. To compensate, lift from the main rotors relative to the tail rotor can be decreased, for example by linkage movement resulting in pivoting the rotors and/or by increasing lift from the tail propeller, for example by increasing the rotational rate of the tail propeller.

Reduction of susceptibility to interference may be accomplished in some embodiments via the creation and control over the direction of downwash air flow. When the main rotors are pivoted as shown in FIG. 9B, for example, downwash air flow can be created which directs the flow of air away from the fuselage leading to a reduction of associated wall and ground effects. The reduction of such interferences as a result of creating downwash air flow can enhance the ability to fly the aircraft in close proximity to obstacles, and improves the control effort when performing landing and taking off maneuvers from any type of terrain, including sloped surfaces, rough terrain. Varying ground or surface conditions may dynamically change the effects of the ground effects on the aircraft making it appear from the pilot's point of view that the aircraft is moving somewhat erratically. Adjustment of the rotor positions can reduce these effects and stabilize aircraft flight

Traditionally, as rotor downwash strikes the surface/ground it splits, a portion of the downwash may diffuse or escape horizontally. Under certain conditions, for example, where the aircraft is flying low to the ground or flying in confined spaces such as urban canyons, obstructions (e.g., buildings, trees), these obstructions may interfere with the escaping airflow, redirecting the escaping air flow in a manner that it re-enters the propeller disc, thereby providing an induced airflow. Such interference and induced airflow may cause erratic behavior of the aircraft, as a result of the irregular shape of the obstructions against which the escaping airflow is redirected, and thus is preferably avoided. The relative distance to the ground or obstructing objects at which induced airflow interferes with rotor function is a function of the size of the aircraft. Full size aircraft, for example may be experience interference at distances of for example less than 10 meters from the ground or other obstacles. At a defined rotor rotational rate and an angle of attack of the blades, the induced flow may result in a reduced angle of attack and reduced total rotor thrust, resulting in a lower obtainable hover height. To avoid losing altitude, the autopilot or pilot must raise the collective (i.e. increase the angle of attack of the rotor blades) to increase lift, which in turn, may further increase the induced flow, requiring even more up collective, and more engine output to maintain the aircraft in the same position. In some embodiments of the present disclosure, interference caused by the induced airflow may be addressed by utilizing the capability of the main rotors 23a and 23b to be angled with respect to the longitudinal axis of the fuselage and produce an associated airflow which is redirected in a manner that produces induced airflow which interferes to a lesser degree with the escaping airflow, notably an associated airflow of which a larger proportion is directed away in a lateral direction from the aircraft, without reentering the propeller disc. As a result the aircraft may remain more stable even when flying in close proximity to obstacles (at the expense of using the ground effects to increase lift with the rotor thrust).

Accordingly, the present disclosure provides, in at least one embodiment, an aircraft that is capable of landing on non-horizontal surfaces, exhibits improved flight stability and control, and has reduced susceptibility to interference as a result of downwash.

It is noted that some embodiments of the rotary wing aircraft of the present disclosure may exclude a tail propeller rotating around a horizontal axis. Such a tail propeller is required for conventional single rotor helicopters, to counteract the torque of the main rotor. In a conventional helicopter, in the absence of a tail propeller rotating around a horizontal axis, the fuselage will rotate. Thus, there may be a risk of damage to the tail propeller in a conventional helicopter, which can be fatal. The rotary wing aircraft of the present embodiment may operate with counter turning rotors which may permit operation of the aircraft with a non-functional tail rotor.

Various embodiments of the aircraft of the present disclosure may be a substantially wingless aircraft. In certain embodiments, the aircraft of the present disclosure may not include fixed or stationary wings, and may be considered a wingless aircraft. In other embodiments, the aircraft may include one or more of the following lift enhancing structures as shown in FIG. 13: a fixed tail wing 130, a canard 133, or one or more substantially horizontal surfaces extending from the fuselage 132, providing lift to the aircraft, in addition to the lift provided by the main rotors 23a and 23b and optionally the tail propeller 27. All of these lift-enhancing structures may also enhance stability and/or provide for lift to the aircraft in addition to the lift provided by the rotors and tail propeller 27 thereby providing for fuel efficiency when the aircraft is airborne.

The example embodiments of the aircraft of the present disclosure may be constructed to have various sizes, and may include, but is not limited to, at least one of hobby aircrafts, drones, unmanned aerial vehicles, and full sized manned helicopters. The example embodiments of the aircraft of the present disclosure may be used for recreational purposes or for commercial purposes, including, without limitation, at least one of search and rescue operations, fire control, urban policing, military operations, package delivery, mining, and pipeline inspections.

Embodiments of the present disclosure may contain one, two or more inventive features of the disclosure. These include, without limitation, one or two tail propellers supported for rotation around a vertical axis; first and second linkages that are moveable so that the first rotational axis and the second rotational axis rotate in a vertical plane that is parallel and spaced apart from the vertical plane of the longitudinal axis of the fuselage; and first and second linkages which are moveable so that the first and second rotational axes pivot out of a vertical plane that is parallel and spaced apart from the vertical plane of the longitudinal axis of the fuselage.

While the applicant's teachings described herein are in conjunction with various embodiments for illustrative purposes, it is not intended that the applicant's teachings be limited to such embodiments as these embodiments described herein are intended to be examples. On the contrary, the applicant's teachings described and illustrated herein encompass various alternatives, modifications, and equivalents, without departing from the embodiments described herein, the general scope of which is defined in the appended claims.

1. A rotary wing aircraft comprising:
a fuselage having a front end, a rear end and a longitudinal axis; and
first and second main rotors, the first main rotor being coupled to the fuselage by a first linkage and supported for rotation around a first rotational axis, the second main rotor being coupled to the fuselage by a second linkage and supported for rotation around a second rotational axis so that the first and second main rotors rotate around the two rotational axes, the two rotational axes being approximately positioned equidistantly on either side of the longitudinal axis of the fuselage, the first and the second main rotors operable to control both horizontal and vertical movement of the aircraft, and the first and second linkages being moveable during use to alter at least one of the angle of the first rotational axis and the angle of the second rotational axis.

2. The rotary wing aircraft according to claim 1 further comprising a tail propeller coupled to the fuselage by a third linkage and supported for rotation around a third rotational axis that is substantially vertical with respect to a plane of the longitudinal axis of the fuselage.

3. The rotary wing aircraft according to claim 2 wherein the tail propeller is mounted on top of a tail boom or suspended from a bottom of the tail boom.

4. (canceled)

5. The rotary wing aircraft according to claim 1 further comprising two tail propellers coupled to the fuselage by a third linkage and supported for rotation around a third rotational axis that is substantially vertical with respect to a plane of the longitudinal axis of the fuselage.

6. The rotary wing aircraft according to claim 5 wherein the two tail propellers are operated to rotate counter-directionally to one another.

7. The rotary wing aircraft according to claim 1 wherein the first and second main rotors rotate counter to each other.

8. The rotary wing aircraft according to claim 1 wherein the first and second linkages are moveable so that the first rotational axis and the second rotational axis rotate in a vertical plane that is parallel and spaced apart from the vertical plane of the longitudinal axis of the fuselage.

9. The rotary wing aircraft according to claim 1 wherein the first and second linkages are independently moveable with respect to one another so that the first and second rotational axes are at different angles in a vertical plane that is parallel and spaced apart from the vertical plane of the longitudinal axis of the fuselage.

10. The rotary wing aircraft according to claim 8 wherein the first and the second rotational axis rotate 360 degrees in a vertical plane that is parallel and spaced apart from the vertical plane of the longitudinal axis of the fuselage.

11. The rotary wing aircraft according to claim 1 wherein the first and second linkages are constructed so that first and second rotational axes are angled out of a vertical plane that is parallel and spaced apart from the vertical plane of the longitudinal axis of the fuselage.

12. The rotary wing aircraft according to claim 1 wherein the first and second linkages are moveable so that the first and second rotational axes pivot out of a vertical plane that is parallel and spaced apart from the vertical plane of the longitudinal axis of the fuselage.

13. The rotary wing aircraft according to claim 1 wherein the first and second linkages are independently moveable with respect to one another so that the first and second rotational axes pivot at different angles out of a vertical plane that is parallel and spaced from the vertical plane of the longitudinal axis of the fuselage.

14. The rotary wing aircraft according to claim 11 wherein the rotational axes are angled at different angles out of a vertical plane that is parallel and spaced apart from the vertical plane of the longitudinal axis of the fuselage at an angle of less than 10 degrees.

15. The rotary wing aircraft according to claim 12 wherein the rotational axes are moveable at different angles out of a vertical plane that is parallel and spaced apart from the vertical plane of the longitudinal axis of the fuselage at angle of less than 10 degrees.

16. The rotary wing aircraft according to claim 8 wherein the first and second linkages comprise first and second spars, each spar transversally extending in opposite direction from the fuselage, and first and second rotor support structures at each distal end of the spar within which are first and second shafts, from which rotor blades radially extend, the first and second shafts being free to turn around first and second rotational axes, respectively, wherein each spar is controlled to rotate around its transversally extending rotational axis permitting rotation of each shaft at different angles in a vertical plane that is parallel and spaced apart from the vertical plane of the longitudinal axis of the fuselage.

17. The rotary wing aircraft according to claim 12 wherein the first and second linkages comprise first and second spars, each spar transversally extending in opposite directions from the fuselage, and distal portions of the spars are attached to first and second rotors, respectively, the first and second rotors having first and second rotational axes wherein each spar is further connected to a longitudinally extending rotatable connecting rod having an axis parallel relative to the longitudinal axis of the fuselage, and wherein rotation of the connecting rod is controlled to permit pivoting of the first and second rotors at different angles out of a vertical plane that is parallel and spaced apart from the vertical plane of the longitudinal axis of the fuselage.

18. The rotary wing aircraft according to claim 1 wherein the first and second rotors comprise rotor blades radially extending from a rotor shaft and linked thereto via a rotatable rotor blade support structure permitting rotation of the rotor blades about the radial axes and control of the angle of attack.

19. The rotary wing aircraft according to claim 2 wherein the propeller comprises propeller blades radially extending from a rotor shaft and linked thereto via a rotatable rotor blade support structure permitting rotation of the rotor blades about the radial axes and control of the angle of attack.

20. The rotary wing aircraft according to claim 1 wherein the aircraft further comprises a lift enhancing structure providing lift to the aircraft in addition to the lift provided by the main rotors, wherein the lift enhancing structure is a fixed tail wing, a canard or one or more substantially horizontal surfaces extending from the fuselage.

21. (canceled)

22. The rotary wing aircraft according to claim 1 wherein the rotary wing aircraft comprises first and second ring structures that are generally co-planar with and surround the first and second rotors so that the first and second rotators rotate within the first and second fixed ring structures.
